(19) United States
(12) Patent Application Publication
(10) Pub. No.: US 2016/0186724 A1
(43) Pub. Date: Jun. 30, 2016

(54) Hybrid Electric Generation Systems for generating cleaner and renewable electric energy

(71) Applicant: Ronald Wendell McCarden, Montgomery, AL (US)

(72) Inventor: Ronald Wendell McCarden, Montgomery, AL (US)

(21) Appl. No.: 14/201,791

(22) Filed: Mar. 7, 2014

(51) Int. Cl. F03D 9/00; B61C 7/04

(52) U.S. Cl. CPC F03D 9/005; F03D 11/02; B61C 7/04

(57) ABSTRACT

An electric generating system that uses components comprised of a modified wind turbine, a modified roller coaster, a modified Ferris wheel, a power transfer assembly along with other prime movers and electric generators to generate cleaner and renewable electricity up to 24 hours a day, almost anywhere in the world, and at a cost competitive with coal-fired generating plants. This system can work without the use of water, wind, or the sun.

### BACKGROUND OF THE INVENTION

1. Field of the Invention

This invention is in the field of electromechanical systems, and relates to the use of a newly designed sub-assemblies working with components in the Hybrid Electric Generation Systems to generate cleaner and renewable electric power.

2. Discussion of Related Art

As of this submission, there has not been any patents published that relate to the use of any of these core sub-assemblies, assemblies, platforms, or systems being used to generate cleaner and renewable electric energy.

With this application, there will be an introduction to a series of new concepts and acronyms. This is necessary because of this innovative platform which components have never been used together for the generation of cleaner and renewable electricity.

a. The prime movers are vital components of our design. Their purpose is to supply the initial and continuing torque necessary to keep the platform in motion. They may consist of a wide range of choices several of which are a plurality of modified wind turbines, a plurality of modified diesel electric train power plants, a plurality of modified biodiesel electric train power plants, and/or a plurality of high horsepower electric motors. The modified wind turbine would be reconfigure so that gears are redirected to send rotational torque down the tower via a series of connecting rods to a gear box located at or near base of the tower. The modified diesel and bio-diesel electric train power plants would be one or a series of stationary locomotive powertrains retrofitted to supply initial and continuing rotational torque to the Closed Roller Coaster Loop Sub-assembly. One or a series of high horsepower electric motors may be used. Their horse power and torque ratings would be sufficient to provide initial and continuing rotational torque to the CRCLS. In each and every case, the prime mover that we may choose to use is readily available and capable of preforming as required.

b. The Closed Loop Roller Coaster Sub-assembly is our novel use of an amusement park attraction for a completely unique purpose when compared to its intended use. It allows our platform to dictate a specific path for our carts weighing x kilograms with extension rods to follow. Our mathematical computations reveal that for the varying diameters chosen, weights of carts used, and prime movers selected, the platforms were able to obtain net torque gains. We are able to perform calculations to determine; beforehand, how much net rotational torque a chosen cart path might yield. Our ability to manipulate the cart's path and alter the cart's weight results in overall system operability. These factors make the Hybrid Electric Generation Systems viable. Our ability to adjust these parameters resulted in positive net torque throughout the full spectrum of platform movement which turned the Torque Multiplier Assembly. The use of CAD software to create a working, digital prototype of our platform proved it practicality and feasibility. It must be clearly noted that the introduction of initial and sustained rotational torque supplied by the prime mover working with our novel Closed Loop Roller Coaster Sub-assembly and Wheel Guide Sub-assembly gives the Torque Multiplier Assembly its power to turn.

c. This overall goal of the Hybrid Electric Generation Systems initiative was to simulate the effects of the wind force on a wind turbine. With that idea in mind, we launched Project-Artificial Wind. We took an in depth look at the forces require to turn a specific wind turbine of x MW at rated speed (the speed in which its output equaled its nameplate). Once we found out how much wind energy in Newton, we set out to design a system or platform to replicate the force of the wind. We analyzed the force of falling water and the force of blowing wind. The Ferris wheel and roller coaster were the two platforms that we felt offered us the best opportunity to use for the project. We knew that if we could simulate the effect of water on one side of the wheel just as if it was coming from the source it would allow us the rotation that we needed. The roller coaster was then reimagined as a means by which a prescribe path could be set. The closed loop within a roller coaster attraction has no value and is deemed impractical so it has never been constructed or proposed. So, we feel extremely confident that our use of one is a first, especially for the field of electric energy generation. When we combined the two dissimilar components together an entirely new platform had been developed and for a completely new reason—the generation of clean energy. As it has been in the past, both the roller coaster and Ferris wheel have been use for entertainment. Our combination of them in a unique and modified format for energy generation is beyond novel and truly innovative. They allow us to solve one of mankind's most pressing challenges to date, the ability to generate in abundance cleaner and renewable electric energy at a price competitive with coal-fired generation. We simply repurpose some of the ordinary platforms that were being used in completely different manners into a new platform or system that generates a universally required commodity—electricity.

d. The use of carts weighing x kilograms (i.e. 500 kg, 1000 kg, 1500 kg or 3000 kg, etc.) with extension rods traveling along a prescribed path has resulted in net rotational torque sufficient to turn a plurality of Modified Ground Mounted Turbines or wind turbine generators at rated speed. The systems can be custom built to match either present or future demand. Our design can use either a plurality of Torque Multiplier Assemblies along with a plurality of generating units to achieve a desired output. Force (N) equals weight (kg)×gravity (m/seĉ2). The Torque is determined by multiplying Force (N)×Radius (m) to get a net total value across all point traveling along a path away from the center of rotation. When the weight of the carts are increased and the diameter of the CRCLS and Wheel Guide Sub-assembly are increased the result is more net rotational torque supplied by the Torque Multiplier Assembly to the Transfer Rod Assembly which turn more electric generating units in the Electric Power Garden. The use of the prime mover for providing initial and continuing rotational torque insure that the Torque Multiplier Assembly never achieves zero torque or comes to rest at any point around the cart path.

e. The physics of several common devices are exploited to accomplish our results which is cleaner and renewable energy up to 24 hours a day, almost anywhere in the world, and at a cost competitive with coal. Presently, solar power arrays generate electricity on average approximately 6.5 hours a day. Wind farms generate electricity on average approximately 25-35% of the time.

The concept for and ability to construct and erect a Roller Coaster is well within the ability for several companies around the world, who have built them safely with loop diameters up to 49 meters. We found no evidence of a closed loop roller coaster being used or proposed for use for the generation of electric energy. The innovative use of the closed loop created a path and dictated the movement of the weighted carts with extension arms to follow. That this travel path would prove invaluable as it along with the force of the carts weighing x kilograms would provide positive net torque for the system. This positive net torque would be crucial for generating rotational torque to the Wheel Guide Sub-assembly. Again, the ingenuity in the application is that it works as a pivotal piece of a system to create cleaner and renewable electric energy. The Closed Roller Coaster Loop Sub-assembly will required a closed loop of x meters in diameters and follow a path specifically establish to generate maximum net torque. It will be supported by separate columns, but share the foundation with the other components.

The concept for and ability to construct and erect a Ferris wheel is well within the capability of companies around the world, who have built them safely with diameters that exceed 150 meters. Our Wheel Guide Sub-assembly is a modification of the Ferris wheel. It will replace passengers with carts weighing x kilograms. It is supported by its own base and only comes in contact with the CRCLS at the point where the rods of the carts weighing x kilograms make contact with the guide arms. The Wheel Guide Sub-assembly will be x meters in diameter and will contain wheel guides that will have a single rod rotating within it confines. As the carts weighing x kilograms with extension rods travel along the prescribe path the extension arm makes contact with the guide arms and rotates the Wheel Guide Sub-assembly. The prime mover, Closed Roller Coaster Loop Sub-assembly, and Wheel Guide Sub-assembly combine to form the Torque Multiplier Assembly.

The concept for and ability to build a Power Transfer Rod is well within the capability for many companies around the world. Our platform will transfer rotational torques from the Torque Multiplier Assembly via the Transfer Rod Assembly to the Electric Power Garden. In addition, the Power Transfer Rod will allow for the collective and individual operation of the plurality of electric generating units thru the use of gears, gear reducers and other practical components.

The Torque Multiplier Assembly has been designed to mimic the effects of the wind on a wind turbine. The sub-assemblies each provided a critical component necessary for this to occur. First, the power or rotational torque provide by the prime mover is not sufficient to turn the plurality of electric generating units of the EPG at rated speed. The carts weighing x kilograms rotating about a designated path is not sufficient to turn the electric generating units of the EPG at rated speed and if left alone would stop at some point. A Wheel Guide Sub-assembly of x meters in diameter is not sufficient to turn the plurality of electric generating units of the EPG at rated speed. But, when these components are combined into the Torque Multiplier Assembly, it then has enough torque differential to turn the Power Transfer Rod and ultimately the electric generating units of the EPG at rated speed.

The concept for the Electric Power Garden was derived after observing the sporadic placement of wind turbines within wind farms to either capture the wind or suit the landscape. It was determined that a more efficient and less costly approach to the wind farm would be the Electric Power Garden. We have more control over the placement of the BEGS. Now, we can avoid out of the way or remote locations. We do not need to disturb any environmentally sensitive area or migratory bird routes. Off shore renewable energy projects can be significantly reduced or avoided all together. The garden would be an M×N array of Modified Ground Mounted Turbines (geared or direct drive) or they may be wind turbine generators (permanent magnet, synchronous or induction). This arrangement will allow for more MW per acre than any other renewable system typically a wind farm may generate 0.015 MW per acre vs up to 30 MW per acre for our system; require less land—a wind farm may need up to 10,000 acres for 150 MW system vs 50 acres for our 150 MW BEG system; provide for greater placement options—typically a wind farm is placed in remote area far from the grid vs our system which can be placed almost anywhere in the world; create less of an environmental impact—we can be sited our platforms away from environmentally sensitive areas such as bat and bird migratory routes. Fragile ecosystems such as lakes, oceans, or other sensitive areas can now be avoided. We can dress up our sites as buildings or potentially place them above ground, partially below ground or completely below ground. Finally, our systems will cost less to build and maintain as they can be retrofitted to previously retire coal-fired power plants thereby extending the life of those facilities. We expect installed cost to be approximately $1-1.5 M per megawatt well below the industry average of $2-2.5 M per MW.

The ability to house either partially or in its entirety the Hybrid Electric Generation Systems in either a building or underground is plausible as this platform will not require wind, water or sun to operate in some variants.

### SUMMARY OF THE INVENTION

The various sub-assemblies and components are combined to assist the Hybrid Electric Generation Systems platform operate in an novel and innovative way for the generation of cleaner and renewable electric energy. The use of commonly available components along with the reinventing of other items such as the roller coaster into a closed loop capable of guaranteeing a viable path of travel for the carts weighing x kilograms. The Ferris wheel frame work reengineered to serve as a waterless wheel of sorts with the carts weighing x kilograms with extension rods designed to act as the force of falling water about the penstock or the force wind blowing against the turbine blades. To its end, Hybrid Electric Generation Systems work because all of the components and sub-assemblies perform to exploit some natural aspects and results in transforming the Torque Multiplier Assembly into an Artificial Waterfall or Artificial Wind capable of spinning a plurality of electric generating units.

### BRIEF DESCRIPTION OF THE DRAWING

FIG. 1 is a perspective view of the Torque Multiplier Assembly consisting of an independently supported Closed Roller Coaster Loop Sub-assembly with carts weighing x kilograms and extension rods, an independently supported Wheel Guide Sub-assembly sharing the same foundation.

FIG. 2 is a perspective view of a prime mover, cart weighing x kilograms with extension rod, guide arms of the Wheel Guide Sub-assembly, and section of the Closed Roller Coaster Loop Sub-assembly.

FIG. 3 is a front view of the Torque Multiplier Assembly showing the Wheel Guide Sub-assembly, the Closed Roller Coaster Loop Sub-assembly, carts weighing x kilograms with extension rods, support columns, and the foundation.

FIG. 4 is a front view of the Electric Power Garden showing a 2×2 matrix of electric generating units connected to the Transfer Rod Assembly.

FIG. 5 is a perspective view of the Hybrid Electric Generation Systems showing one of many possible layouts. It shows a Torque Multiplier Assembly connected to a Transfer Rod Assembly which is connected to an Electric Power Garden.

### DETAILED DESCRIPTION OF THE DRAWINGS

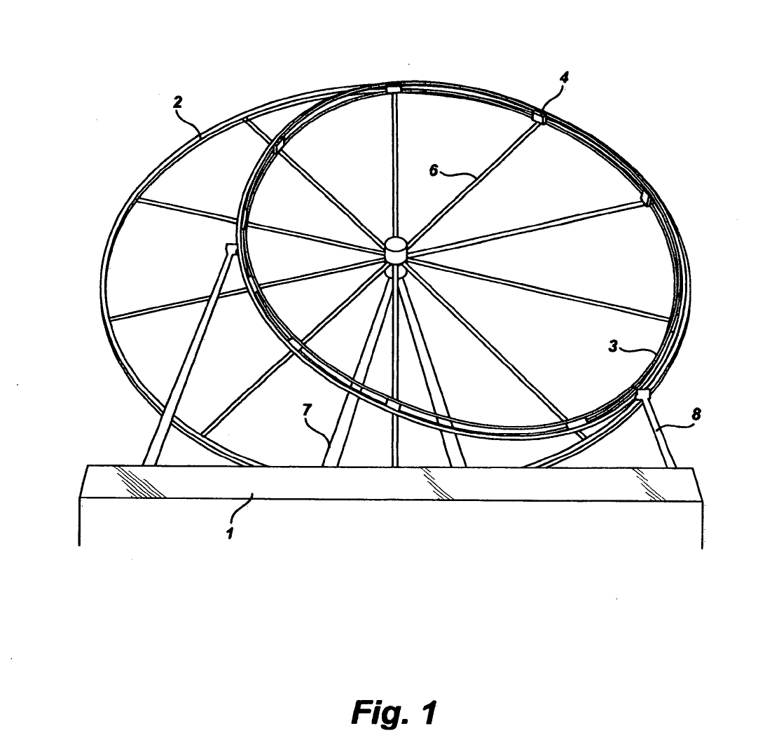

FIG. 1 Shows a perspective view of a Torque Multiplier Assembly, in this example the unit is supported by the foundation (1), for both the Closed Roller Coaster Loop Sub-assembly (3) and Wheel Guide Sub-assembly (2). Although CRCLS (2) and WGS (3) share the same foundation (1), the two subassemblies do not connect or contact at any other point with the exception of where the extension rods meet, which is attached to the cart weighing x kilograms (4) makes contact with the guide arms (6). The carts weighing x kilograms with extension rods (4) around a preset path. The plurality of carts weighing x kilograms with extension rods (4) press against the guide arms (6) and force the Wheel Guide Sub-assembly (2) to rotate.

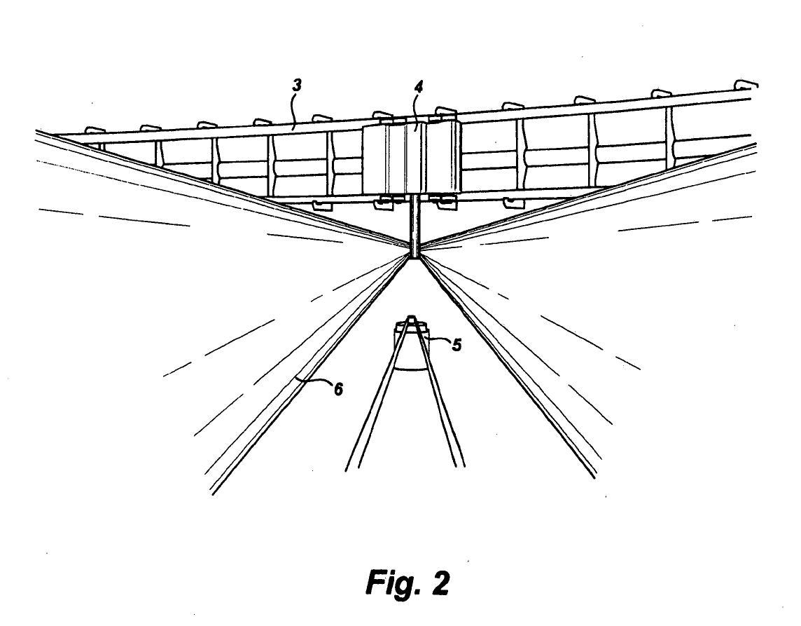

FIG. 2 is a partial plan view of a high horsepower electric motor (5) one of the several proposed prime movers. The cart weighing x kilograms with extension rod (4) rolling along the CRCLS (3). The extension rods roll between the guide arms (6) and make contact with the guide arms which causes the entire Torque Multiplier Assembly to spin.

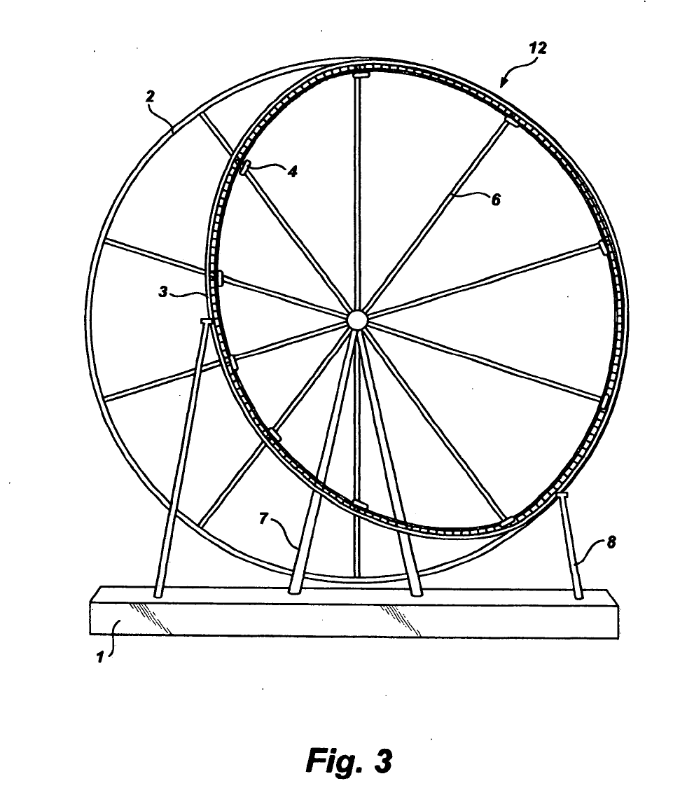

FIG. 3 is a front view of a Torque Multiplier Assembly (12) showing Wheel Guide Sub-assembly (2) along with the Guide Arms (6). The support (7) is for the WGS (2); whereas, the support (8) is for the CRCLS (3). Both sub-assemblies share the same axis and foundation (1).

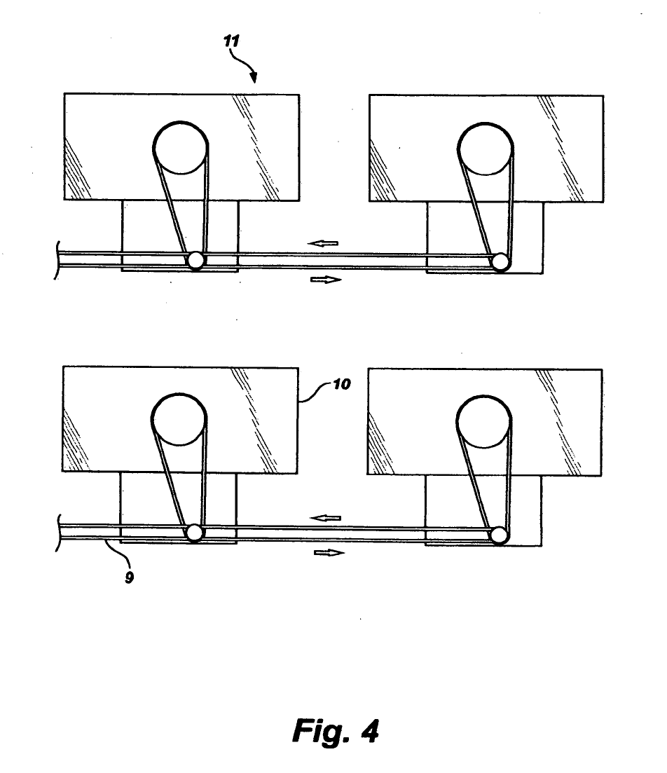

FIG. 4 is a front view of an Electric Power Garden (11) featuring a plurality of electric generating units (10) and connect to one another via Transfer Rod Assembly (9).

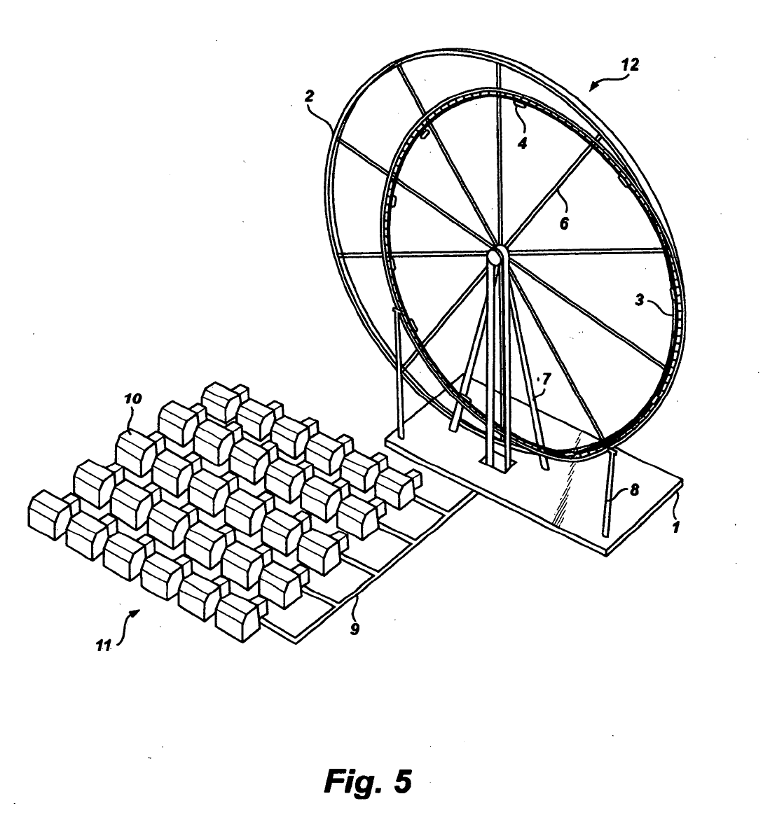

FIG. 5 is a perspective view of a possible layout for the Hybrid Electric Generation Systems. It shows a Torque Multiplier Assembly (TMA) (12) consisting of a Wheel Guide Sub-assembly (2) as carts weighing x kilograms with extension rods (4) travel along the path of the Closed Roller Coaster Loop Sub-assembly (3) and rolls within the confines of the guide arms (6) causing the TMA to rotate with enough torque to spin the Transfer Rod Assembly (9) and subsequently the plurality of electric generating units (10) which in this view is an Electric Power Garden (11) shown here as an 5×5 array.

The invention claimed is:

1. Hybrid Electric Generation Systems (HEGS) for generating cleaner and renewable electric energy, comprising: a. at least one prime mover which may be either one or a plurality of modified wind turbines, one or a plurality of modified diesel electric trains, one or a plurality of modified biodiesel electric trains, one or a plurality of wind generators, and/or one or a plurality of electric motors from which the initial and continuing source of rotational torque will be supplied; b. at least one Closed Roller Coaster Loop Sub-assembly (CRCLS) which receives the initial and continuing rotational torque from the prime mover and acts as a designated route for carts weighing x kilograms with extension rods to travel at x meters away from the axis of rotation; c. a plurality of carts weighing x kilograms with extension rods that will travel around the predetermined path and whose extension arms will roll within the boundaries of the guide arms attached to the Wheel Guide Sub-assembly (WGS); d. at least one Wheel Guide Sub-assembly that has a plurality of guide arms attached. The carts weighing x kilograms with extension rod makes contact with the walls of the guide arms and cause the WGS to rotate. The rotating carts and WGS become a Torque Multiplier Assembly and connect to the Transfer Rod Assembly; e. at least one Transfer Rod Assembly (TRA) which will transfer the rotational torque from the Torque Multiplier Assembly (TMA) which is the result of the combining of the prime mover, CRCLS and the WGS sub components into one dedicated platform that will ultimately turn the Electric Power Garden (EPG); while allowing for the attachment and detachment of the individual generating units of the Electric Power Garden; f. at least one Electric Power Garden which is an M×N matrix or array of electric generating units.

2. Torque Multiplier Assembly is comprised of at least one prime mover, at least one Closed Roller Coaster Loop Sub-assembly, a plurality of carts weighing x kilograms with extension rods, and at least one Wheel Guide Sub-assembly.

3. Electric Power Garden which will consist of an M×N matrix or array of electric generating units.

4. The renewable energy system of claim 1, wherein said prime movers are capable of providing initial and continuing rotational torques to the Closed Roller Coaster Loop Sub-assembly.

5. The renewable energy system of claim 2, wherein said Closed Roller Coaster Loop Sub-assembly which having a radius of x meters transfers the initial rotational and continuing rotational torques into kinetic energy to propel the carts weighing x kilograms with extension rods in motion along their prescribed path.

6. The renewable energy system of claim 1, wherein said carts weighing x kilograms with extension rods whose movement is constrained and set within the confines of the guide arms of a Wheel Guide Sub-assembly. The carts weighing x kilograms with extension rods traveling along a prescribed path make contact with the guide arms causing the rotation of the Wheel Guide Sub-assembly.

7. The renewable energy system of claim 2, wherein said Torque Multiplier Assembly aided by the carts weighing x kilograms with extension rods traveling along a prescribed path will achieve rotational torque which will be transferred to the Transfer Rod Assembly.

8. The renewable energy system of claim 6, wherein said Transfer Rod Assembly will be capable of turning both collectively and individually the electric generating units that make up the Electric Power Garden.

9. The renewable energy system of claim 3, wherein said Electric Power Garden is comprised of electric generating units that may consist of Modified Ground Mounted Turbine (geared, gearless or direct drive) and/or specially configured wind turbine generators (permanent magnet, synchronous or induction).

10. The renewable energy system of claim 9, wherein said Modified Ground Mounted Turbines or wind turbine generator would combine to achieve a desired megawatt output based on the rotational torque supplied by the Torque Multiplier Assembly.

11. The renewable energy system of claim 10, wherein the Modified Ground Mounted Turbine is a standard wind turbine that has had the blades and hub removed, the tower shortened to a height at or near ground level, the base reconfigured to accommodate the lighter load, all non-essential electronics and gears removed, additionally the hub is replaced with a sprocket plate and connects to the Transfer Rod Assembly.

12. The renewable energy system of claim 11, wherein the electric energy output from the array of electric generating units is sent to the grid via at least one transformer.
